(19) United States
(12) Patent Application Publication
(10) Pub. No.: US 2026/0194872 A1
(43) Pub. Date: Jul. 9, 2026

(54) CONTROL DEVICE, LEARNING DEVICE, CONTROL METHOD, LEARNING METHOD, AND RECORDING MEDIUM

(71) Applicants: NEC Corporation, Tokyo (JP); NATIONAL INSTITUTE OF ADVANCED INDUSTRIAL SCIENCE AND TECHNOLOGY, Tokyo (JP)

(72) Inventors: Makoto SAKAHARA, Tsukuba-shi (JP); Shumpei KUBOSAWA, Tsukuba-shi (JP); Takashi ONISHI, Tsukuba-shi (JP); Yoshimasa TSURUOKA, Tsukuba-shi (JP)

(73) Assignees: NEC Corporation, Tokyo (JP); NATIONAL INSTITUTE OF ADVANCED INDUSTRIAL SCIENCE AND TECHNOLOGY, Tokyo (JP)

(21) Appl. No.: 19/121,951

(22) PCT Filed: Sep. 29, 2023
(86) PCT No.: PCT/JP2023/035680

§ 371 Date: Apr. 17, 2025

(30) Foreign Application Priority Data
Nov. 1, 2022 (JP) 2022-175607

(51) Int. Cl. G05B 13/04

(52) U.S. Cl. CPC G05B 13/041

(57) ABSTRACT

A control device searches for a function included in the objective function so as to achieve a best possible stability evaluation based on the objective function by using an objective function indicating a stability condition based on a Lyapunov function. The control device searches for a control rule for a control target so as to achieve a best possible stability evaluation based on the objective function, and determines a control command for the control target based on the obtained control rule. The control device controls the control target based on the control command.

### TECHNICAL FIELD

The present invention relates to a control device, a learning device, a control method, a learning method, and a recording medium.

### BACKGROUND ART

As one method for achieving control stability, a method using a Lyapunov function is known.

For example, Patent Document 1 discloses that if a Lyapunov function can be discovered, the stability of a nonlinear model can be guaranteed.

### PRIOR ART DOCUMENTS

### Patent Document

Patent Document 1: Japanese Unexamined Patent Application, First Publication No. 2021-189934

### SUMMARY

### Technical Problem

No general method is known for obtaining a Lyapunov function. In this regard, obtaining a Lyapunov function to achieve control stability imposes a significant burden on the operator responsible for finding a Lyapunov function. It is preferable to achieve control stability without the need to manually discover a Lyapunov function in advance.

An example of an object of the present disclosure is to provide a control device, a learning device, a control method, a learning method, and a recording medium capable of solving the problems mentioned above.

### Solution to Problem

According to a first example aspect of the present disclosure, a control device includes: a function acquisition means that searches for a function included in the objective function so as to achieve a best possible stability evaluation based on the objective function by using an objective function indicating a stability condition based on a Lyapunov function; an action determination means that searches for a control rule for a control target so as to achieve a best possible stability evaluation based on the objective function, and determines a control command for the control target based on the obtained control rule; and a control execution means that controls the control target based on the control command.

According to a second example aspect of the present disclosure, a learning device includes: a function acquisition means that searches for a function included in the objective function so as to achieve a best possible stability evaluation based on the objective function by using an objective function indicating a stability condition based on a Lyapunov function; and an action determination means that searches for a control rule for a control target so as to achieve a best possible stability evaluation based on the objective function, and determines a control command for the control target based on the obtained control rule.

According to a third example aspect of the present disclosure, a control method executed by a computer includes: searching for a function included in the objective function so as to achieve a best possible stability evaluation based on the objective function by using an objective function indicating a stability condition based on a Lyapunov function; searching for a control rule for a control target so as to achieve a best possible stability evaluation based on the objective function, and determining a control command for the control target based on the obtained control rule; and controlling the control target based on the control command.

According to a fourth example aspect of the present disclosure, a learning method executed by a computer includes: searching for a function included in the objective function so as to achieve a best possible stability evaluation based on the objective function by using an objective function indicating a stability condition based on a Lyapunov function; and searching for a control rule for a control target so as to achieve a best possible stability evaluation based on the objective function, and determining a control command for the control target based on the obtained control rule.

According to a fifth example aspect of the present disclosure, a recording medium has stored therein a program that causes a computer to execute: searching for a function included in the objective function so as to achieve a best possible stability evaluation based on the objective function by using an objective function indicating a stability condition based on a Lyapunov function; searching for a control rule for a control target so as to achieve a best possible stability evaluation based on the objective function, and determining a control command for the control target based on the obtained control rule; and controlling the control target based on the control command.

According to a sixth example aspect of the present disclosure, a recording medium has stored therein a program that causes a computer to execute: searching for a function included in the objective function so as to achieve a best possible stability evaluation based on the objective function by using an objective function indicating a stability condition based on a Lyapunov function; and searching for a control rule for a control target so as to achieve a best possible stability evaluation based on the objective function, and determining a control command for the control target based on the obtained control rule.

### Advantageous Effects of Invention

According to the present disclosure, it is expected that control stability can be achieved without the need to manually discover a Lyapunov function in advance.

### BRIEF DESCRIPTION OF DRAWINGS

FIG. 1 is a diagram showing a configuration example of a control system according to some of the example embodiments of the present disclosure.

FIG. 2 is a diagram showing a configuration example of a control device according to some of the example embodiments of the present disclosure.

FIG. 3 is a diagram showing an example of a data flow in a case where a real-state-data acquisition unit according to some of the example embodiments of the present disclosure acquires real-state data under control for a control target.

FIG. 4 is a diagram showing an example of a data flow in a case where a latent-state-data acquisition unit according to some of the example embodiments of the present disclosure performs learning of a mapping from a real state to a latent state.

FIG. 5 is a diagram showing an example of a data flow in a case where an action determination unit according to some of the example embodiments of the present disclosure performs learning of a control rule for a control target in a latent state.

FIG. 6 is a diagram showing an example of a data flow in the control device during additional learning and inference according to some of the example embodiments of the present disclosure.

FIG. 7 is a diagram showing an example of a procedure of processing for learning a control rule for a control target performed by the control device according to some of the example embodiments of the present disclosure.

FIG. 8 is a diagram showing an example of a data flow in the control device in a case where the control system according to some of the example embodiments of the present disclosure is operated.

FIG. 9 is a diagram showing an example of a configuration example of a control device for exclusive use during operation in a case where Lyapunov rewards are not calculated, according to some of the example embodiments of the present disclosure.

FIG. 10 is a diagram showing another configuration example of the control device according to some of the example embodiments of the present disclosure.

FIG. 11 is a diagram showing a configuration example of a learning device according to some of the example embodiments of the present disclosure.

FIG. 12 is a diagram showing an example of a processing procedure in a control method according to some of the example embodiments of the present disclosure.

FIG. 13 is a diagram showing an example of a processing procedure in the learning method according to some of the example embodiments of the present disclosure.

FIG. 14 is a schematic block diagram showing a configuration of a computer according to at least one of the example embodiments.

### EXAMPLE EMBODIMENT

Hereinafter, an example embodiment of the present disclosure will be described, however, the present invention within the scope of the claims is not limited by the following example embodiment. Furthermore, not all the combinations of features described in the example embodiments are essential for the solving means of the invention.

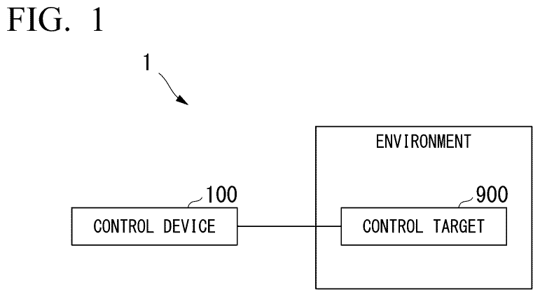

FIG. 1 is a diagram showing a configuration example of a control system according to some of the example embodiments of the present disclosure. In the configuration shown in FIG. 1, a control system 1 includes a control device 100 and a control target 900.

The control system 1 is a system that causes a control target 900 to perform stable operation. The stable operation of the control target 900, as referred to herein, is that the control target 900 operates in such a way that the values related to the operation of the control target 900 are maintained at a constant target value or a value close to the constant target value.

The control target 900 is not limited to a specific one and can be various things that are controllable and are expected to perform stable operations.

For example, in the case where the control target 900 is an air conditioning unit, an example of stable operation would be to adjust the ambient temperature, such as room temperature, to a set temperature and to operate to maintain the set temperature. Moreover, in the case where the control target 900 is a car's cruise control system, an example of stable operation would be to maintain the car's traveling speed at a constant value. Moreover, in the case where the control target 900 is a power generation plant, an example of stable operation would be to operate so that the generated power reaches a set power and to maintain the set power.

The control device 100 performs learning of a control rule for the control target 900 so as to cause the control target 900 to operate stably, and controls the control target 900. Specifically, the control device 100 searches for a control rule applicable to the control target 900 by solving an optimization problem that uses an objective function indicating the stability condition based on a Lyapunov function, aiming to achieve a best possible stability evaluation as defined by the objective function.

The process of learning a control rule is also referred to as learning control.

The control device 100 refers to an example of the learning device.

The control device 100, or portions thereof, may be configured using a computer, such as a personal computer, a workstation, or a programmable logic controller (PLC).

The process by which the control device 100 performs learning of a control rule for the control target 900 can be considered a form of reinforcement learning. The reinforcement learning, as referred to herein, is a type of machine learning in which a policy, which is an action rule of an agent that takes actions in a given environment, is learned based on the state in the environment and the reward that represents the evaluation of the state or action.

The control device 100 refers to an example of the agent, and the control performed by the control device 100 on the control target 900 refers to an example of the action. A control rule for the control device 100 to determine a control command for the control target 900 refers to an example of the policy.

The process of determining a control command is also referred to as determining control.

The control device 100 may learn a control rule for the control target 900 based on the observed state of the real operating environment of the control target 900. In such a case, the operating environment of the control target 900 refers to an example of the environment in the reinforcement learning. The state observed in the operating environment of the control target 900 refers to an example of the state related to the control target 900.

Here, the operating environment of the control target 900 is considered to include the control target 900 itself. The state related to the control target 900 may be a state of the control target 900 itself, or it may be a state observed outside the control target 900, or it may include both of these.

Alternatively, as will be described later, the control device 100 may learn a control rule for the control target 900 based on a state obtained by converting the observed state, rather than the observed state itself, of the real operating environment of the control target 900.

In such a case, a virtual environment associated with the real operating environment of the control target 900 refers to an example of the environment in the reinforcement learning. The state observed in the virtual environment refers to an example of the state related to the control target 900.

In the following description, the real operating environment of the control target 900 will also be referred to as “real environment” or “real space”. A virtual environment associated with a real environment will also be referred to as “latent environment” or “latent space”. A state in a real environment will also be referred to as “real state”. Data indicating a real state will also be referred to as “real-state data”. A variable representing a real state will also be referred to as “state variable”, and a real state or a state variable will be represented by x. A real state (value of state variable x) or real-state data at time t will be represented as xₜ.

A state in an latent environment will also be referred to as “latent state”. Data indicating a latent state will also be referred to as “latent-state data”. A variable representing a latent state will also be referred to as “latent variable”, and a latent state or a latent variable will be represented by z. A latent state (value of latent variable z) or the latent-state data at time t will be represented as zₜ.

A control command for the control target 900 will be represented by u. A control command at time t will be represented as uₜ. A control command for the control target 900 will also be referred to as “action”.

A control rule for determining a control command for the control target 900 will also be referred to as “policy”.

In the following description, time will be represented in time steps of time width Δt, and will be represented as time step 0, time step 1, time step 2, . . . , time step t, time step t+1, . . . , and so on. Time step 0, time step 1, time step 2, . . . , time step t, time step t+1, . . . , and so on will also be represented as time 0, time 1, time 2, . . . , time t, time t+1, . . . , and so on.

The length of the time width Δt may be constant, or it may vary for each time step.

A description will be provided regarding stability conditions based on a Lyapunov function, which the control device 100 employs for learning a control rule applicable for the control target 900.

Here, t represents an independent variable that assumes real values, while z represents a dependent variable that takes the values of an n-dimensional real vector. Also, let the function f(z) be a function that maps an n-dimensional real vector to a real number, and let the ordinary differential equation shown in Expression (1) be an autonomous system with an equilibrium point at the origin, z=0.

$$[ Math . 1 ]$$

$$\frac{dz}{dt} = f ( z ) \qquad ( 1 )$$

For instance, a condition for global asymptotic stability is the existence of a function V, referred to as a Lyapunov function, that satisfies the following Expression (2) through Expression (4) across the entire domain of z. The first condition for global asymptotic stability is represented as Expression (2).

$$[ Math . 2 ]$$

$$V ( 0 ) = 0 \qquad ( 2 )$$

The second condition for global asymptotic stability is represented as Expression (3).

$$[ Math . 3 ]$$

$$\begin{matrix}V ( z ) > 0 , & z \neq 0\end{matrix} \qquad ( 3 )$$

A function that satisfies Expression (2) and Expression (3) is referred to as a Lyapunov candidate function.

The third condition for global asymptotic stability is represented as Expression (4).

$$[ Math . 4 ]$$

$$\begin{matrix}\frac{dV ( z )}{dt} < 0 , & z \neq 0\end{matrix} \qquad ( 4 )$$

If a function V exists that satisfies Expression (2) through Expression (4), then the equilibrium point at the origin z=0 exhibits global asymptotic stability, meaning that all solution trajectories converge to the origin z=0.

In the control for the control target 900, t can be considered to represent time, and z can be considered to represent a latent variable or latent state. Moreover, the ordinary differential equation shown in Expression (1) can be considered to represent the transition of the latent state z under the control for the control target 900.

If a function V exists that satisfies Expression (2) through Expression (4), the control device 100 can control the control target 900 so that the latent state z converges to the origin z=0.

The equilibrium point can be moved from the origin, z=0, to an arbitrary point by means of a translation of coordinates. Therefore, if the control device 100 can perform control that satisfies the conditions for global asymptotic stability, control can be performed on the control target 900 with any value, not limited to 0, as the target value.

Also, the condition that a function V exists that satisfies Expression (2) through Expression (4) in a neighborhood B of the origin, z=0, corresponds to the condition for asymptotic stability, and in this case, the function V is referred to as a Lyapunov function. If a function V exists that satisfies the condition of asymptotic stability, the control device 100 can control the control target 900 so that the latent state z converges to the origin, z=0, in the case where the time series of the latent state remains in the neighborhood B.

In such a case also, the control device 100 can control the control target 900 by setting any value, not limited to 0, as the target value.

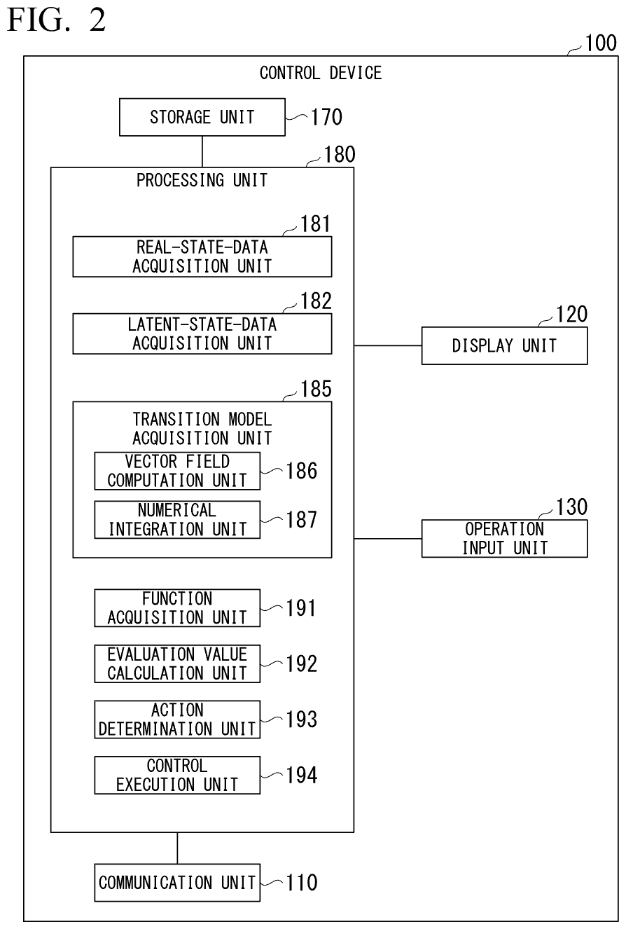

FIG. 2 is a diagram showing a configuration example of the control device 100. In the configuration shown in FIG. 2, the control device 100 includes a communication unit 110, a display unit 120, an operation input unit 130, a storage unit 170, and a processing unit 180. The processing unit 180 includes a real-state-data acquisition unit 181, a latent-state-data acquisition unit 182, a transition model acquisition unit 185, a function acquisition unit 191, an evaluation value calculation unit 192, an action determination unit 193, and a control execution unit 194. The transition model acquisition unit 185 includes a vector field computation unit 186 and a numerical integration unit 187.

The communication unit 110 communicates with other devices. For example, the communication unit 110 may receive real-state data indicating a real state from a state observation sensor installed in the real environment. Moreover, the communication unit 110 may transmit control commands to the control target 900.

The display unit 120 includes a display screen such as a liquid crystal panel or an LED (light emitting diode) panel, and displays various types of images. For example, the display unit 120 may display various information such as a target value in control for the control target 900, real-state data, or a value of the objective function.

The operation input unit 130 includes input devices such as a keyboard and a mouse, and accepts user operations. For example, the operation input unit 130 may receive a user operation for setting or changing a target value in the control for the control target 900.

The storage unit 170 stores various types of data. The storage unit 170 is configured using a storage device included in the control device 100.

The processing unit 180 controls each unit of the control device 100 and executes various processes. Functions of the processing unit 180 are executed by a CPU (central processing unit) included in the control device 100, reading out a program from the storage unit 170 and executing the program.

The real-state-data acquisition unit 181 acquires real-state data in a case where the control device 100 controls the control target 900.

The real-state-data acquisition unit 181 refers to an example of the real-state-data acquisition means.

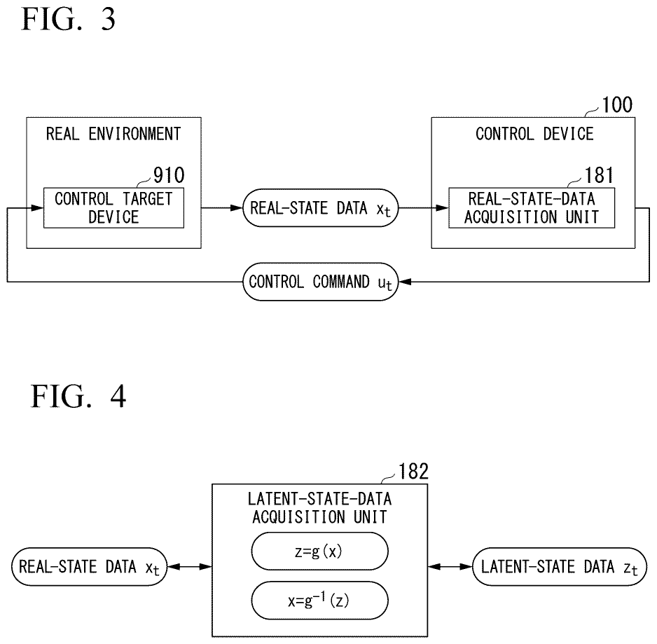

FIG. 3 is a diagram showing an example of the data flow in a case where the real-state-data acquisition unit 181 acquires real-state data under control for the control target 900.

In the example of FIG. 3, the control device 100 determines a control command uₜ, and transmits the determined control command uₜ to the control target 900 to thereby control the control target 900. Moreover, the real-state-data acquisition unit 181 acquires real-state data xₜ. For example, the real-state-data acquisition unit 181 extracts real-state data from received data received by the communication unit 110 from a sensor installed in the real environment.

In a case where the real-state-data acquisition unit 181 acquires real-state data, the control device 100 may randomly determine the control command uₜ for the control target 900 from among control command candidates. Alternatively, the action determination unit 193 may determine the control command uₜ, or the real-state-data acquisition unit 181 may determine the control command uₜ.

By repeating acquisition of real-state data xₜ by the real-state-data acquisition unit 181 and determination and transmission of the control command uₜ by the control device 100, the real-state-data acquisition unit 181 acquires time-series data of the control command for the control target 900 and time-series data of the real state in a case where the control target 900 follows the control. The combination of time-series data of a control command and time-series data of a real state refers to an example of the training data using real-state data to indicate the state transitions under control for the control target 900. The training data using real-state data to indicate the state transitions under the control for the control target 900, is also referred to as training data based on real-state data.

Alternatively, the real-state-data acquisition unit 181 may acquire a dataset Dx of three-element data (xₜ, uₜ, xₜ₊₁) consisting of real-state data xₜ, control command uₜ, and real-state data xₜ₊₁ indicating the subsequent state xₜ₊₁ of the real-state data xₜ. The data set Dx refers to an example of the training data that uses real-state data to indicate state transitions under the control for the control target 900.

The latent-state-data acquisition unit 182 performs learning of the conversion from real-state data to latent-state data, and converts the data based on the learning result. The latent-state-data acquisition unit 182 refers to an example of the latent-state-data acquisition means.

In particular, the latent-state-data acquisition unit 182 performs learning of a diffeomorphism from a real state to a latent state. For example, the latent-state-data acquisition unit 182 is configured to include a neural network, and performs learning of a diffeomorphism using a normalizing flow.

FIG. 4 is a diagram showing an example of a data flow in a case where the latent-state-data acquisition unit 182 performs learning of a mapping from a real state to a latent state.

In the example of FIG. 4, the latent-state-data acquisition unit 182 performs learning of a diffeomorphism z=g(x) that converts real-state data xₜ into latent-state data zₜ, and its inverse mapping x=g⁻¹ (z). The inverse mapping of a diffeomorphism is also a diffeomorphism. The inverse mapping x=g⁻¹ (z) refers to a diffeomorphism that converts latent-state data zₜ into real-state data xₜ.

The latent-state-data acquisition unit 182 performs learning using the Normalizing Flow, thereby obtaining a diffeomorphism and its inverse mapping. However, the method by which the latent-state-data acquisition unit 182 performs learning may be any method capable of acquiring a diffeomorphism and its inverse mapping, and is not limited to a specific method.

Here, a general method for obtaining a Lyapunov function or a Lyapunov candidate function has not been identified. Therefore, obtaining a Lyapunov function is generally not easy.

On the other hand, a diffeomorphism allows for the mapping of control stability. Specifically, in a case of mapping a space using a diffeomorphism, the region in the pre-mapping state space where control stability can be obtained is mapped, by the diffeomorphism, to the region in the post-mapping state space where control stability can be obtained.

By mapping the real environment (state space of real state) to the latent environment (state space of latent state) using a diffeomorphism, the latent-state-data acquisition unit 182 can replace the acquisition of a Lyapunov function in the real environment with the acquisition of a Lyapunov function in the latent environment. For example, if a region satisfying the conditions for asymptotic stability in the latent environment can be detected, control stability can also be achieved in the corresponding region in the real environment, which is obtained by applying the inverse mapping of the mapping from the real environment to the latent environment to that region.

Moreover, the mapping performed by the latent-state-data acquisition unit 182 is expected to enable mapping of the real environment to an environment where the acquisition of a Lyapunov function is relatively easier. For example, by mapping from the real space to the latent space, a complex distribution of trajectories (trajectory of change in x indicating the real state) determined by the initial state (initial condition) and the vector field dx/dt in the real space is mapped to a simpler distribution of trajectories (trajectory of change in z indicating the latent state) determined by the initial state and the vector field dz/dt in the latent space, which is expected to make it relatively easy to calculate the loss in the Lyapunov function.

However, the control device 100 may learn a control rule for the control target 900 in the real state. In such a case, the control device 100 need not include the latent-state-data acquisition unit 182. In the case where the control device 100 performs learning of a control rule for the control target 900 in the real state, z representing the latent state in Expression (1) through Expression (4) is replaced with x representing the real state.

The transition model acquisition unit 185 trains a latent-state transition model. The latent-state transition model is a model that indicates the transition of the latent state according to the control for the control target 900, and outputs latent-state data that indicates the next state in the latent state in response to input of latent-state data and a control command.

For example, the transition model acquisition unit 185 trains the latent-state transition model using, as training data, a data set D_{z} of three-element data (zₜ, uₜ, zₜ₊₁) consisting of a combination of latent-state data zₜ at time t, a control command uₜ for the control target 900 at time t, and latent-state data zₜ₊₁ indicating the next state zₜ₊₁ of the latent state zₜ.

The data set D_{z} is obtained by the latent-state-data acquisition unit 182 converting the real-state data included in the data set Dx into latent-state data. The data set D_{z} refers to an example of the training data that uses latent-state data to indicate state transitions under the control for the control target 900. The training data using latent-state data to indicate the state transitions under the control for the control target 900, is also referred to as training data based on latent-state.

The transition model acquisition unit 185 corresponds to an example of the transition model acquisition means.

The transition model acquisition unit 185 uses the obtained latent-state transition model to calculate and output latent-state data zₜ₊₁ indicating the next state zₜ₊₁ of the latent state data zₜ in response to input of the latent state data zₜ.

In the following description, an example will be described in which the latent-state transition model is configured to include a vector field indicating the time derivative of the latent state and a numerical integral of the time derivative of the latent state indicated by the vector field.

The vector field computation unit 186 performs learning of a vector field that indicates the time derivative of the latent state, and calculates the time derivative of the latent state using the obtained vector field. In particular, the vector field computation unit 186 receives the latent-state data zₜ and a control command uₜ for the control target 900 as input, and performs learning of a vector field indicating the time derivative of the latent state under the control for the control target 900. Then, the vector field computation unit 186 uses the obtained vector field to calculate the time derivative of the latent state under the control for the control target 900.

Here, the vector field represents the value of the time derivative dz/dt of the latent state for each latent state (value of latent variable z) represented by a vector. This vector field can be considered as a model representing the ordinary differential equation shown above in Expression (1).

The numerical integration unit 187 performs numerical integration of the time derivative of the latent state output by the vector field computation unit 186. In particular, the numerical integration unit 187 receives input of latent-state data z₀ indicating the initial state of the latent state, and calculates the latent state zₜ₊₁ at time t+1 by performing numerical integration of the time derivative dz/dt of the latent state up to time t output by the vector field computation unit 186.

The combination of the vector field computation unit 186 and the numerical integration unit 187 refers to an example of the latent-state transition model.

The method by which the transition model acquisition unit 185 trains the latent-state transition model is not limited to a specific method. For example, the vector field computation unit 186 is configured to include a neural network. In such a case, the transition model acquisition unit 185 can train the latent-state transition model by employing a known technique that leverages neural networks to learn ordinary differential equations under the conditions of actions in reinforcement learning.

The function acquisition unit 191 performs learning of the Lyapunov function. Specifically, the function acquisition unit 191, in an optimization problem using an objective function indicating a condition of stability by the Lyapunov function, performs a search for a function included in the objective function so as to achieve a best possible stability evaluation by the objective function.

The function acquisition unit 191 refers to an example of the function acquisition means.

The function shown in Expression (5) can be used as the objective function indicating the condition for stability using the Lyapunov function.

$$[ Math . 5 ]$$

$$r = - max ( 0 , \frac{\partial V}{\partial z} \frac{dz}{dt} ) - max ( 0 , - V ( z ) ) - {V}^{2} ( 0 ) \qquad ( 5 )$$

The function V is an example of the function included in the objective function.

The term “(∂V/∂z)(dz/dt)” in Expression (5) is a transformed expression of “dV(z)/dt” in Expression (4), derived using the chain rule shown in Expression (6).

$$[ Math . 6 ]$$

$$\frac{dV ( z )}{dt} = \frac{\partial V}{\partial z} \frac{dz}{dt} \qquad ( 6 )$$

max represents a function that outputs the maximum value among the argument values. The value of “max(0, (∂V/∂z)(dz/dt))” becomes 0 in a case where (∂V/∂z)(dz/dt)≤0 and takes a value greater than 0 in a case where (∂V/∂z)(dz/dt)>0.

Thus, if Expression (4) holds, then max (0, (∂V/∂z)(dz/dt))=0. On the other hand, in a case where dV(z)/dt>0, then max (0, (∂V/∂z)(dz/dt))>0.

The value of “max (0, −V(z))” becomes 0 if Expression (3) holds and takes a value greater than 0 in a case where V (z)<0.

The value of “V²(0)” becomes 0 if Expression (2) holds and takes a value greater than 0 if Expression (2) does not hold.

Expression (5) takes a value of 0 or negative, and the larger the value of Expression (5) (that is, the closer the value of Expression (5)) is to 0, the better the stability evaluation. In a case where all the conditions shown from Expression (2) through Expression (4) are satisfied, Expression (5) takes its maximum value of 0. The value of Expression (5) is also referred to as negative Lyapunov reward (Lyapunov penalty), represented by r.

For example, consider the case where both the function acquisition unit 191 and the action determination unit 193 are configured using neural networks. In the case where the function acquisition unit 191 uses a neural network to learn the Lyapunov function, various neural networks with differentiable and continuous activation functions can be used, and the Lyapunov function is differentiable. Moreover, the ordinary differential equations learned by the transition model acquisition unit 185 are also differentiable.

By the differentiability of both the Lyapunov function and the ordinary differential equation, the objective function shown in Expression (5) becomes a differentiable immediate reward with respect to the control rule for the control target. Specifically, the objective function shown in Expression (5) is differentiable with respect to the parameters of the neural network constituting the function acquisition unit 191 and the parameters of the neural network constituting the action determination unit 193. This allows the learning of the neural network constituting the function acquisition unit 191, and the learning of the neural network constituting the action determination unit 193, to be performed using gradient methods such as backpropagation.

For example, the N-step discounted reward sum Rₜ^{(N)} of the negative Lyapunov reward rₜ at each time t is shown as in Expression (7).

$$[ Math . 7 ]$$

$${R}_{t}^{( N )} = {\sum }_{t = {t}_{0}}^{{t}_{0} + N} {γ}^{t - {t}_{0}} {r}_{t} \qquad ( 7 )$$

t₀ represents the start time of the N steps considered for the calculation of the discounted reward sum.

N is a constant integer where N≥1.

γ is a constant indicating the discount rate of future reward values from time to. For the negative Lyapunov reward rₜ at time t, r^{t_t0} is multiplied by γ raised to the power of the time (the number of steps in time steps) t-t₀ from time t₀ to time t.

The N-step discounted reward sum, Rₜ^{(N)}, can be expressed as a function of the parameters of both the neural network constituting the function acquisition unit 191 and the neural network constituting the action determination unit 193, and it is differentiable with respect to these parameters.

Here, the parameters of the neural network constituting the function acquisition unit 191 and the parameters of the neural network constituting the action determination unit 193 are represented by θ. By referring to the gradient ∂Rₜ^{(N)}/∂θ and searching for the value of θ to maximize the N-step discounted reward sum Rₜ^{(N)} toward 0, the learning of the neural network constituting the function acquisition unit 191 and the neural network constituting the action determination unit 193 can be performed. Maximizing the N-step discounted reward sum Rₜ^{(N)} refers to an example of maximizing the negative Lyapunov reward r.

The latent-state transition model acquired by the transition model acquisition unit 185 can also be trained using a similar calculation method. The learning of the latent-state transition model refers to modifying the dynamics itself to ensure that the latent space dynamics satisfies stability condition.

Even if the function acquisition unit 191 searches for a function V using the objective function shown in Expression (5), it does not necessarily obtain a function that satisfies the condition of global asymptotic stability or a function that satisfies the condition of asymptotic stability. For example, there may be a case where the function acquisition unit 191 cannot obtain a function V that makes the negative Lyapunov reward r 0.

Even in the case where the function acquisition unit 191 cannot obtain a function V that makes the negative Lyapunov reward r 0, it is expected that the control device 100 will be able to learn relatively stable control by acquiring a function V that maximizes the negative Lyapunov reward r (as close to 0 as possible).

For example, consider the case where Expression (2) and Expression (3) hold over the entire region of the latent state that may be subject to control for the control target 900, and where, for Expression (4), there is a region where dV(z)/dt<0 and a region where dV(z)/dt≥0. In such a case, it is conceivable that the latent state approaches the origin z=0 in the region where dV(z)/dt<0, and the latent state moves away from the origin z=0 in the region where dV(z)/dt≥0.

At this time, by acquiring a function V that maximizes the negative Lyapunov reward r, the function acquisition unit 191 can make the value of dV(z)/dt relatively small even in the region where dV(z)/dt≥0, and it is conceivable that the distance by which the latent state moves away from the origin z=0 is relatively small. It is expected that the latent state approaches the origin z=0 because the distance by which the latent state approaches the origin z=0 in the region where dV(z)/dt<0, is greater than the distance by which the latent state moves away from the origin z=0 in the region where dV(z)/dt=0.

Also, the condition that a function V exists that satisfies Expression (2), Expression (3), and Expression (8) in a neighborhood B of the origin, z=0, corresponds to the condition for Lyapunov stability, and in this case, the function V is referred to as Lyapunov function.

$$[ Math . 8 ]$$

$$\begin{matrix}\frac{dV ( z )}{dt} \leq 0 , & z \neq 0\end{matrix} \qquad ( 8 )$$

In a case where a function V exists that satisfies the condition for Lyapunov stability, the control device 100 can perform control for the control target 900 so that the time series of the latent state remains within the neighborhood of the origin z=0.

In such a case also, the control device 100 can control the control target 900 by setting any value, not limited to 0, as the target value.

Therefore, in the case where the function acquisition unit 191 acquires a function that satisfies a Lyapunov stability condition, it is expected that the control device 100 will be able to perform control such that the latent state remains within a certain neighborhood of the origin z=0, even if it is unable to control the latent state to converge to the origin z=0.

Additionally, the control device 100 may also narrow the region targeted for Lyapunov function learning toward the equilibrium point, for example, by limiting the region targeted for Lyapunov function learning to within a predetermined distance from the equilibrium point. Specifically, the control device 100 may also limit the data used for Lyapunov function learning, to data within a predetermined region relatively close to the equilibrium point. As a result, the computational load in Lyapunov function learning can be reduced.

On the other hand, in a case where the control device 100 designates a broader region for Lyapunov function learning, the stability of control may be ensured over a broader region compared to the case where the region is restricted.

The objective function used by the function acquisition unit 191 is not limited to that shown in Expression (5). For example, the function acquisition unit 191 may use an objective function in which a smaller value indicates a better stability evaluation. The values of the objective function indicating stability evaluation are collectively referred to as Lyapunov rewards.

The evaluation value calculation unit 192 calculates the value of the objective function. For example, in the case where the function acquisition unit 191 uses the objective function shown in Expression (5), the evaluation value calculation unit 192 calculates a negative Lyapunov reward r.

For example, the evaluation value calculation unit 192 acquires the value of the differential dz/dt calculated by the vector field computation unit 186 and the function V acquired by the function acquisition unit 191, and calculates the value of the objective function.

The action determination unit 193 performs learning of a control rule for the control target 900. In particular, the action determination unit 193 uses the same objective function as the objective function used by the function acquisition unit 191 to learn the Lyapunov function, and searches for a control rule for the control target 900 so as to achieve the best possible stability evaluation by the objective function. For example, the action determination unit 193 searches for a control rule in model-based reinforcement learning using the objective function shown in Expression (5) so as to maximize the negative Lyapunov reward r.

The action determination unit 193 determines a control command for the control target 900 using the obtained control rule.

The action determination unit 193 refers to an example of the action determination means.

The control execution unit 194 performs control over the control target 900 based on the control command determined by the action determination unit 193. For example, the control execution unit 194 controls the communication unit 110 to transmit a control command to the control target 900.

The control execution unit 194 refers to an example of the control execution means. The combination of the action determination unit 193 and the control execution unit 194 refers to an example of an agent in reinforcement learning.

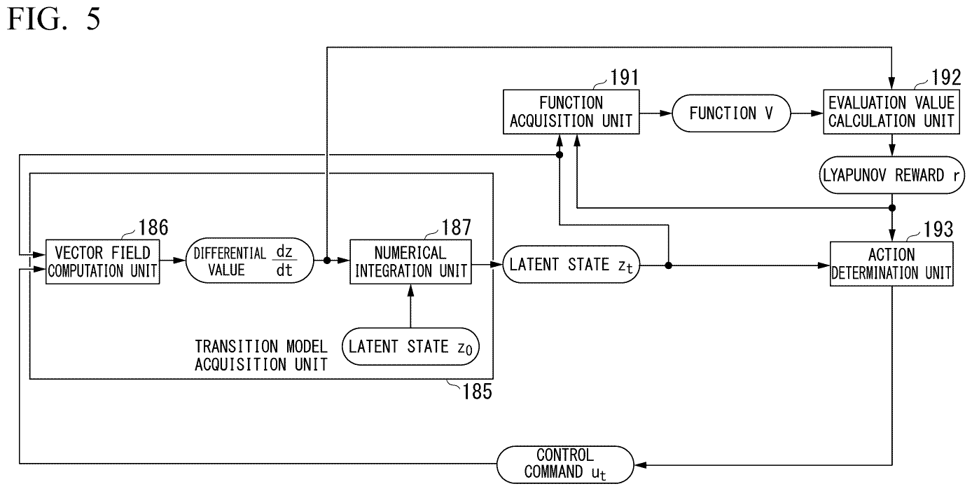

FIG. 5 is a diagram showing an example of a data flow in a case where the action determination unit 193 performs learning of a control rule for the control target 900 in a latent state. In the example of FIG. 5, the action determination unit 193 performs learning of a control rule for the control target 900. Moreover, the function acquisition unit 191 performs learning of a Lyapunov function for evaluating the stability of the control learned by the action determination unit 193.

Furthermore, prior to the learning of the control rule by the action determination unit 193 and the learning of the Lyapunov function by the function acquisition unit 191, the transition model acquisition unit 185 trains the latent-state transition model to calculate the next state in the latent state corresponding to the control for the control target 900 determined by the action determination unit 193. Alternatively, the training of the latent-state transition model by the transition model acquisition unit 185 may be performed in parallel with the learning of a control rule by the action determination unit 193 and the learning of the Lyapunov function by the function acquisition unit 191.

In the example of FIG. 5, the action determination unit 193 determines a control command uₜ for the control target 900 in accordance with the latent state zₜ at the time step t.

The transition model acquisition unit 185 calculates the latent state zₜ₊₁ at time step t+1, which is the next state for the latent state zₜ, in response to the control command uₜ determined by the control target 900. Specifically, the vector field computation unit 186 calculates the value of the time derivative dz/dt of the latent variable z according to the latent state zₜ and the control command uₜ. The numerical integration unit 187 numerically integrates the time series of the time derivative dz/dt of the latent variable z based on the initial state z₀ of the latent state. Thereby, the numerical integration unit 187 calculates the latent state data zₜ₊₁ (data indicating the latent state zₜ₊₁).

The action determination unit 193 and the transition model acquisition unit 185 repeat, at each time step, determining a control command according to the latent state and calculating a next state according to the control command.

Furthermore, the function acquisition unit 191 performs learning of the Lyapunov function based on the latent state calculated by the transition model acquisition unit 185 and the negative Lyapunov reward r calculated by the evaluation value calculation unit 192, and calculates the function V. The purpose of the learning performed by the function acquisition unit 191 is to acquire a Lyapunov function, but as described above, the function V is not necessarily a Lyapunov function.

The evaluation value calculation unit 192 receives as input the function V calculated by the function acquisition unit 191 and the value of dz/dt calculated by the vector field computation unit 186, and uses the function V to calculate a negative Lyapunov reward.

In relation to the learning of the Lyapunov function performed by the function acquisition unit 191, the negative Lyapunov reward r can be considered as an evaluation index indicating the degree to which the function V calculated by the function acquisition unit 191 satisfies the conditions for being a Lyapunov function. The function acquisition unit 191 performs learning of the Lyapunov function so as to maximize the value of the negative Lyapunov reward r.

The function acquisition unit 191 and the evaluation value calculation unit 192 repeat both the learning of the Lyapunov function and the calculation of the function V, and the calculation of the negative Lyapunov reward r using the function V at each time step.

Moreover, the evaluation value calculation unit 192 also outputs the calculated negative Lyapunov reward r to the action determination unit 193. In relation to the learning of a control rule for the control target 900 performed by the action determination unit 193, the negative Lyapunov reward r can be considered as an evaluation index indicating the degree to which the control for the control target 900 by the action determination unit 193 satisfies the stability conditions based on the Lyapunov function. The action determination unit 193 performs learning of the control rule for the control target 900 so as to maximize the value of the negative Lyapunov reward r.

Thus, the action determination unit 193 acquires the latent state data zₜ₊₁ corresponding to the control command uₜ determined by the action determination unit 193 itself, from the transition model acquisition unit 185, and acquires the negative Lyapunov reward r corresponding to the latent state data zₜ₊₁ and the value of the differential dz/dt indicating the state transition from the evaluation value calculation unit 192. The action determination unit 193 uses these data to search for a control rule through model-based reinforcement learning.

After the learning of the control rule for the control target 900 in the latent state is completed, the control device 100 may perform additional learning for fine-tuning the control for the control target 900 in the real environment.

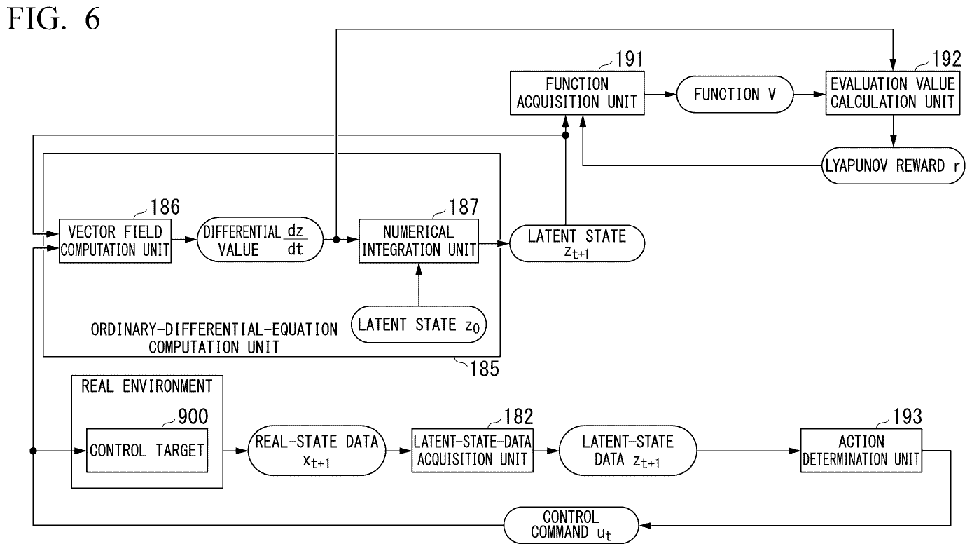

FIG. 6 is a diagram showing an example of a data flow in the control device 100 during additional learning and inference (in a case where the control system 1 is in operation).

In the example of FIG. 6, the action determination unit 193 determines a control command uₜ for the control target 900, and notifies the control target 900 of the determined control command uₜ via the control execution unit 194.

The control target 900 operates in accordance with the control command uₜ, and the real state transitions according to the operation of the control target 900.

The latent-state-data acquisition unit 182 converts real-state data xₜ₊₁ obtained by observing the real environment into latent-state data zₜ₊₁.

The action determination unit 193 determines a control command uₜ₊₁ for the control target 900 in accordance with the latent-state data zₜ₊₁, and notifies the control target 900 of the determined control command uₜ₊₁.

The action determination unit 193, the control target 900, and the latent-state-data acquisition unit 182 repeat both the determination of a control command for the control target 900 and the notification of the control command, the operation in accordance with the control command, and the conversion from the real-state data to the latent-state data at each time step.

The latent-state-data acquisition unit 182 converts the real-state data xₜ₊₁ into the latent-state data zₜ₊₁, whereby the action determination unit 193 can control the control target 900 by using the control rule obtained through the learning in the example of FIG. 5.

During additional learning, the action determination unit 193 performs the learning of the control for the control target 900 in addition to the control for the control target 900. In such a case, the action determination unit 193 may learn the control rule by using an objective function different from the objective function used for learning in the example of FIG. 5. For example, in the case where the control target 900 is an air conditioning unit and the control target 900 is controlled so that the ambient temperature to be adjusted maintains a set temperature, the action determination unit 193 may use an objective function that indicates a better evaluation as the measured ambient temperature approaches the set temperature. In such a case, an evaluation function that uses ambient temperature data from the real environment, or an evaluation function that uses ambient temperature data from the latent environment may be used.

Alternatively, the action determination unit 193 may learn the control rule using the negative Lyapunov reward r calculated by the evaluation value calculation unit 192, as with the case of the example in FIG. 5.

Moreover, the action determination unit 193 outputs the control command uₜ to the transition model acquisition unit 185.

The data flow and processing in the transition model acquisition unit 185, the function acquisition unit 191, and the evaluation value calculation unit 192 are the same as those in the case of FIG. 5. The transition model acquisition unit 185 calculates the next state of the latent state in response to the control command determined by the control target 900 at each time step. The function acquisition unit 191 and the evaluation value calculation unit 192 repeat both the learning of the Lyapunov function and the calculation of the function V, and the calculation of the negative Lyapunov reward r using the function V at each time step.

The user can check the stability evaluation of the control by referring to the negative Lyapunov reward r calculated by the evaluation value calculation unit 192.

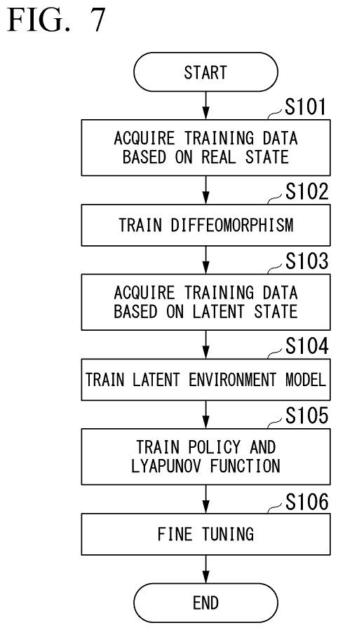

FIG. 7 is a diagram showing an example of a procedure of processing for learning a control for the control target 900 performed by the control device 100.

In the process of FIG. 7, the real-state-data acquisition unit 181 acquires training data based on real state (Step S101).

Next, the latent-state-data acquisition unit 182 performs learning of a diffeomorphism that maps the real state to the latent state (Step S102). Then, the latent-state-data acquisition unit 182 acquires training data in the latent state by using the mapping obtained by learning (Step S103).

Next, the transition model acquisition unit 185 trains the environment model using training data based on the latent state (Step S104).

Next, the function acquisition unit 191 performs learning of the Lyapunov function, and the action determination unit 193 performs learning of the control rule for the control target 900 (Step S105). In particular, the function acquisition unit 191 calculates the function V based on the latent-state data calculated by the transition model acquisition unit 185, and performs learning of the Lyapunov function so as to maximize the negative Lyapunov reward r using the function V calculated by the evaluation value calculation unit 192. Moreover, the action determination unit 193 calculates a control command based on the latent-state data calculated by the transition model acquisition unit 185, and performs learning of a control rule for the control target 900 so as to maximize the negative Lyapunov reward r calculated by the evaluation value calculation unit 192.

The function acquisition unit 191 and the action determination unit 193 repeat the learning of the Lyapunov function and the learning of the control rule for the control target 900 until a learning end condition in the latent environment of control for the control target 900 is met.

The end condition here is not limited to a particular condition. For example, the end condition here may be a condition where the learning in the latent environment of the control for the control target 900 is repeated for a predetermined number of steps at each time step. Alternatively, the end condition here may be a condition where the value of the negative Lyapunov reward r is greater than a predetermined threshold value.

After the processing unit 180 determines that the end condition for the learning in the latent environment of the control for the control target 900 is satisfied, the action determination unit 193 performs fine-tuning of the control for the control target 900 (Step S106).

As described with reference to FIG. 6, in the fine-tuning, the action determination unit 193 determines a control command and performs learning of a control rule, using the latent-state data obtained by the latent-state-data acquisition unit 182 mapping the real-state data. The function acquisition unit 191 also performs learning of the Lyapunov function in Step S106. The evaluation value calculation unit 192 also calculates the negative Lyapunov reward r in Step S106.

The function acquisition unit 191 and the action determination unit 193 repeat the learning of the Lyapunov function and the fine-tuning of the control for the control target 900 until the end condition for the fine-tuning is met.

The end condition here is not limited to a particular condition. For example, the end condition here may be a condition where the learning of the control rule for the control target 900 in fine-tuning has been repeated a predetermined number of times in the time step. Alternatively, the end condition here may be a condition where the control rule for the action determination unit 193 to calculate a control command has not been changed for a predetermined number of steps or more in the time step.

After Step S106, the control device 100 ends the process of FIG. 7.

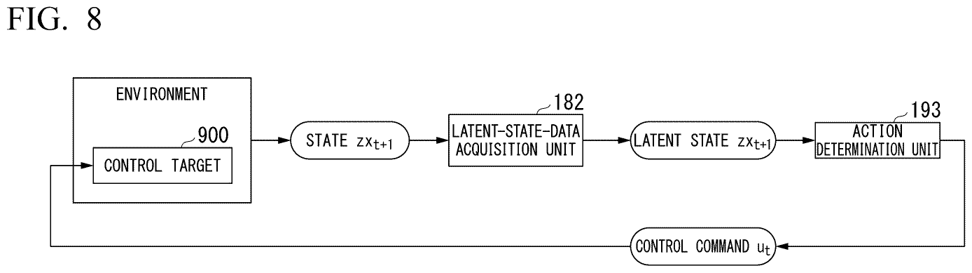

FIG. 8 is a diagram showing another example of a data flow in the control device 100 in a case where the control system 1 is in operation. FIG. 8 shows an example in which the Lyapunov reward is not calculated. In the example of FIG. 8, the data flow and processing in the action determination unit 193, the control target 900, and the latent-state-data acquisition unit 182 are the same as those in FIG. 6.

The action determination unit 193, the control target 900, and the latent-state-data acquisition unit 182 repeat the determination and transmission of a control command for the control target 900, the operation in accordance with the control command, and the conversion from the real-state data to the latent-state data at each time step.

On the other hand, in the example of FIG. 8, among the units shown in FIG. 6, the transition model acquisition unit 185, the function acquisition unit 191, and the evaluation value calculation unit 192 are not shown. Each of these units performs various processes to acquire the function V corresponding to the control command calculated by the control target 900 and to calculate the negative Lyapunov reward r using the acquired function V. On the other hand, in the example of FIG. 8, since the calculation of the negative Lyapunov reward r is not performed, the transition model acquisition unit 185, the function acquisition unit 191, and the evaluation value calculation unit 192 are not shown, as mentioned above.

Even in the case where the calculation of the negative Lyapunov reward r is not performed as mentioned above, the control device 100 shown in FIG. 2 may also be used during the operation of the control system 1. In such a case, the control device 100 may use the units shown in FIG. 8 among the units shown in FIG. 2 to perform processing during operation.

Alternatively, a control device 200 may be provided separately from the control device 100 for exclusive use during operation.

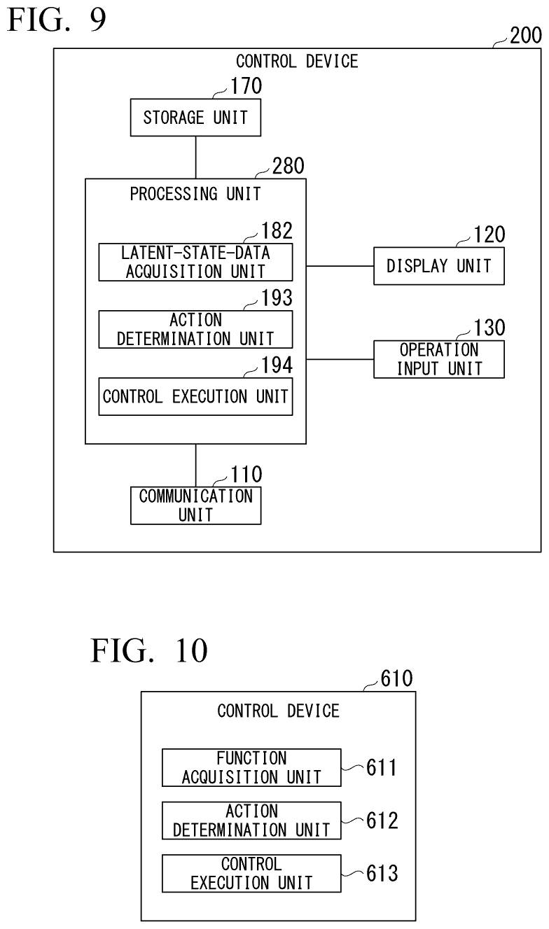

FIG. 9 is a diagram showing an example of a configuration example of a control device for exclusive use during operation in a case where Lyapunov rewards are not calculated.

In the configuration shown in FIG. 9, the control device 200 includes a communication unit 110, a display unit 120, an operation input unit 130, a storage unit 170, and a processing unit 280. The processing unit 280 includes a latent-state-data acquisition unit 182, an action determination unit 193, and a control execution unit 194.

Of the units shown in FIG. 9, ones corresponding to those in FIG. 1 and having the same functions are given the same reference symbols (110, 120, 130, 170, 182, 193, and 194), and descriptions thereof are omitted.

The control device 200 differs from the control device 100 in that the processing unit 280 includes only a portion of the components of the processing unit 180 of the control device 100. In other respects, the control device 200 is similar to the control device 100.

In the example of FIG. 9, the processing unit 280 includes an action determination unit 193 and a latent-state-data acquisition unit 182 shown in FIG. 8, and a control execution unit 194 that performs control for the control target 900 based on control commands determined by the action determination unit 193.

In the example of FIG. 9, it is assumed that the latent-state-data acquisition unit 182 has already acquired a diffeomorphism. Therefore, in the example of FIG. 9, the latent-state-data acquisition unit 182 need not include a function of learning diffeomorphism.

Moreover, as described above, the transition model acquisition unit 185, the function acquisition unit 191, and the evaluation value calculation unit 192 acquire the function V corresponding to the control command calculated by the control target 900, and perform various processes to calculate the negative Lyapunov reward r using the obtained function V. These are not shown in FIG. 9 because they are not necessary in those cases where the calculation of the negative Lyapunov reward r is not performed.

In a case of using the control device 200 instead of the control device 100 during the operation of control system 1, the settings of each unit in the control device 200 may be made based on the learning results from the control device 100. In particular, the mapping obtained through the learning performed by the latent-state-data acquisition unit 182 of the control device 100 may be set in the latent-state-data acquisition unit 182 of the control device 200. Moreover, the control rule obtained by the action determination unit 193 of the control device 100 through learning may be set in the action determination unit 193 of the control device 200.

As having been described in the foregoing, the function acquisition unit 191 uses an objective function indicating a stability condition based on a Lyapunov function, and searches for a function included in the objective function so as to achieve a best possible stability evaluation based on the objective function. The action determination unit 193 searches for a control rule for a control target 900 so as to achieve a best possible stability evaluation based on the objective function, and determines a control command for the control target based on the obtained control rule. The control execution unit 194 performs control over the control target 900 based on the obtained control command.

According to the control device 100, by having the function acquisition unit 191 search for a function using an objective function that indicates the condition for stability using the Lyapunov function, it is expected that control stability can be obtained without the need to manually discover the Lyapunov function in advance. Even in the case where the Lyapunov function cannot be obtained by the function search performed by the function acquisition unit 191, the function acquisition unit 191 searches for a function that achieves a best possible stability evaluation based on the objective function, and it is expected that control stability can be obtained, as described above.

Moreover, the real-state-data acquisition unit 181 acquires training data indicating a transition of a state related to the control target 900 under control for the control target 900 using real-state data that indicates a real state, which is a state related to the control target 900 in a real environment. The latent-state-data acquisition unit 182 converts training data indicating a transition of a state related to the control target 900 under control for the control target 900 as real-state data, into training data indicating a transition of a state related to the control target 900 under control for the control target 900 as latent-state data indicating a latent state, which is a state in a virtual environment. The transition model acquisition unit 185 trains the latent-state transition model by using training data that indicates, as latent-state data, the transition of a state related to the control target 900 under the control for the control target 900. The latent-state transition model is a model that calculates the state transition of the latent state under the control for the control target 900. The latent state is a state indicated by latent-state data. The function acquisition unit 191 searches for a function, using latent-state data output by the latent-state transition model. The action determination unit 193 searches for a control rule for the control target 900, using latent-state data output by the latent-state transition model.

According to the control device 100, the function acquisition unit 191 can search for the function V in the latent environment. In this respect, according to the control device 100, it is expected that the function acquisition unit 191 can perform learning of the Lyapunov function in an environment in which the acquisition of a Lyapunov function is relatively easy.

Moreover, the latent-state-data acquisition unit 182 performs learning of diffeomorphism, and uses the obtained diffeomorphism to convert training data indicating a transition of a state related to the control target 900 under control for the control target 900 as real-state data, into training data indicating a transition of a state related to the control target 900 under control for the control target 900 as latent-state data.

In the control device 100, the real state can be mapped to a latent state through diffeomorphism, and the acquisition of the Lyapunov function in the real environment can be replaced with the acquisition of the Lyapunov function in the latent environment. For example, if a region satisfying the conditions for asymptotic stability using the Lyapunov function in the latent environment can be detected, control stability can also be achieved in the corresponding region in the real environment, which is obtained by applying the inverse mapping of the diffeomorphism from the real environment to the latent environment to that region.

Moreover, the latent-state transition model includes a vector field indicating a time derivative of the latent state, and a numerical integration of a time derivative of a latent state indicated by the vector field. The transition model acquisition unit 185 performs learning of this vector field.

According to the control device 100, the time derivative of the latent state indicated by the vector field can be used to calculate the value of the objective function, and separate calculation of the time derivative of the latent state is not necessary for calculating the value of the objective function. According to the control device 100, in this respect, the computational load can be relatively reduced.

Moreover, the action determination unit 193 further searches for a control rule for the control target 900, using latent-state data obtained by converting the real-state data obtained under control for the control target 900 in a real environment, by the latent-state-data acquisition unit 182.

According to the control device 100, it is expected that the search of a control rule for the control target 900 can be performed with higher accuracy.

FIG. 10 is a diagram showing another configuration example of a control device according to some of the example embodiments of the present disclosure. In the configuration shown in FIG. 10, a control device 610 includes a function acquisition unit 611, an action determination unit 612, and a control execution unit 613.

In this configuration, the function acquisition unit 611 uses an objective function indicating a stability condition based on a Lyapunov function, and searches for a function included in the objective function so as to achieve a best possible stability evaluation based on the objective function. The action determination unit 612 searches for a control rule for a control target so as to achieve a best possible stability evaluation based on the objective function. The control execution unit 613 performs control over the control target based on the obtained control rule.

The function acquisition unit 611 refers to an example of the function acquisition means. The action determination unit 612 refers to an example of the action determination means. The control execution unit 613 refers to an example of the control execution means.

According to the control device 610, by having the function acquisition unit 611 search for a function using an objective function that indicates the condition for stability using the Lyapunov function, it is expected that control stability can be obtained without the need to manually discover the Lyapunov function in advance. Even in the case where the Lyapunov function cannot be obtained by the function search performed by the function acquisition unit 611, the function acquisition unit 611 searches for a function that achieves a best possible stability evaluation based on the objective function, and it is expected that control stability can be obtained.

The function acquisition unit 611 can be implemented using the functions of the function acquisition unit 191 and so forth shown in FIG. 2, for example. The action determination unit 612 can be implemented using the functions of the action determination unit 193 and so forth shown in FIG. 2, for example. The control execution unit 613 can be implemented using the functions of the control execution unit 194 and so forth shown in FIG. 2, for example.

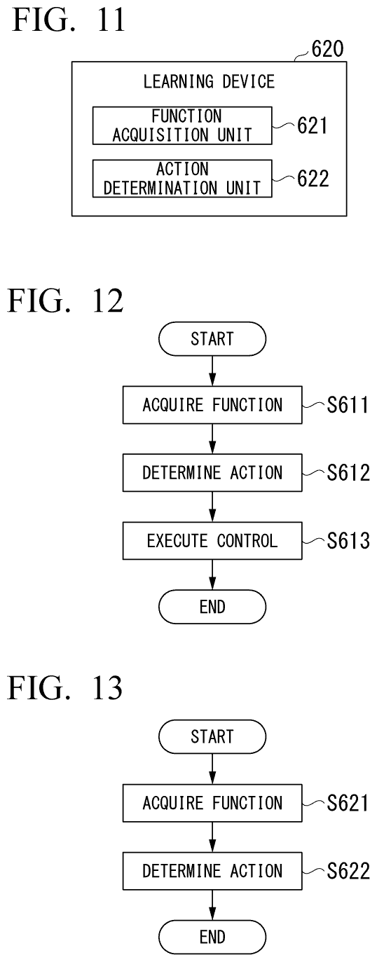

FIG. 11 is a diagram showing a configuration example of a learning device according to some of the example embodiments of the present disclosure. In the configuration shown in FIG. 11, a learning device 620 includes a function acquisition unit 621 and an action determination unit 612.

In this configuration, the function acquisition unit 621 uses an objective function indicating a stability condition based on a Lyapunov function, and searches for a function included in the objective function so as to achieve a best possible stability evaluation based on the objective function. The action determination unit 622 searches for a control rule for a control target so as to achieve a best possible stability evaluation based on the objective function.

The function acquisition unit 621 refers to an example of the function acquisition means. The action determination unit 622 refers to an example of the action determination means.

According to the learning device 620, by having the function acquisition unit 621 search for a function using an objective function that indicates the condition for stability using the Lyapunov function, it is expected that control stability can be obtained without the need to manually discover the Lyapunov function in advance. Even in the case where the Lyapunov function cannot be obtained by the function search performed by the function acquisition unit 621, the function acquisition unit 621 searches for a function that achieves a best possible stability evaluation based on the objective function, and it is expected that control stability can be obtained.

The function acquisition unit 621 can be implemented using the functions of the function acquisition unit 191 and so forth shown in FIG. 2, for example. The action determination unit 622 can be implemented using the functions of the action determination unit 193 and so forth shown in FIG. 2, for example.

FIG. 12 is a diagram showing an example of a processing procedure in a control method according to some of the example embodiments of the present disclosure. The control method shown in FIG. 12 includes a step of acquiring a function (Step S611), a step of determining an action (Step S612), and a step of executing control (Step S613).

In the step of acquiring a function (Step S611), a computer uses an objective function indicating a stability condition based on a Lyapunov function, and searches for a function included in the objective function so as to achieve a best possible stability evaluation based on the objective function.

In the step of determining an action (Step S612), the computer searches for a control rule for a control target so as to achieve a best possible stability evaluation based on the objective function.

In the step of executing control (Step S613), the computer performs control over the control target based on the obtained control rule.

According to the control method shown in FIG. 12, by searching for a function using an objective function that indicates the condition for stability using the Lyapunov function, it is expected that control stability can be obtained without the need to manually discover the Lyapunov function in advance. Even in the case where the Lyapunov function cannot be obtained through function search, by searching for a function that achieves a best possible stability evaluation based on the objective function, it is expected that control stability can be obtained.

FIG. 13 is a diagram showing an example of a processing procedure in a learning method according to some of the example embodiments of the present disclosure. The learning method shown in FIG. 13 includes a step of acquiring a function (Step S621) and a step of determining an action (Step S622).

In the step of acquiring a function (Step S621), a computer uses an objective function indicating a stability condition based on a Lyapunov function, and searches for a function included in the objective function so as to achieve a best possible stability evaluation based on the objective function.

In the step of determining an action (Step S622), the computer searches for a control rule for a control target so as to achieve a best possible stability evaluation based on the objective function.

According to the learning method shown in FIG. 13, by searching for a function using an objective function that indicates the condition for stability using the Lyapunov function, it is expected that control stability can be obtained without the need to manually discover the Lyapunov function in advance. Even in the case where the Lyapunov function cannot be obtained through function search, by searching for a function that achieves a best possible stability evaluation based on the objective function, it is expected that control stability can be obtained.

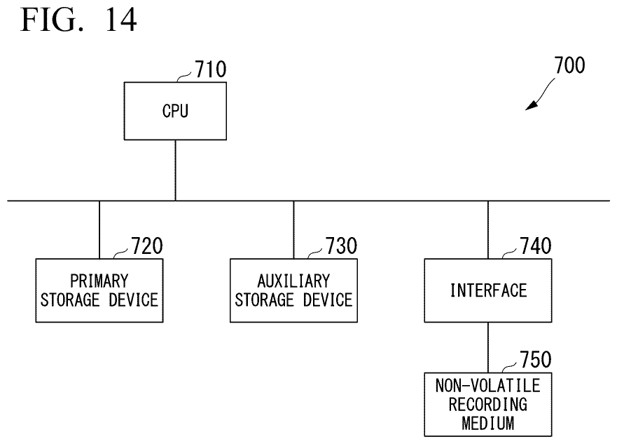

FIG. 14 is a schematic block diagram showing a configuration of a computer according to at least one of example embodiments.

In the configuration shown in FIG. 14, a computer 700 includes a CPU 710, a primary storage device 720, an auxiliary storage device 730, an interface 740, and a non-volatile recording medium 750.

One or more of the control device 100, the control device 200, the control device 610, and the learning device 620 mentioned above or part thereof may be implemented in the computer 700. In such a case, operations of the respective processing units described above are stored in the auxiliary storage device 730 in the form of a program. The CPU 710 reads out the program from the auxiliary storage device 730, loads it on the primary storage device 720, and executes the processing described above according to the program. Moreover, the CPU 710 secures, according to the program, memory storage regions corresponding to the respective storage units mentioned above, in the primary storage device 720. Communication between each device and other devices is executed by the interface 740 having a communication function and communicating under the control of the CPU 710. The interface 740 also has a port for the non-volatile recording medium 750, and reads information from the non-volatile recording medium 750 and writes information to the non-volatile recording medium 750.

In the case where the control device 100 is implemented in the computer 700, operations of the processing unit 180 and each component thereof are stored in the form of a program in the auxiliary storage device 730. The CPU 710 reads out the programs from the auxiliary storage device 730, loads them on the primary storage device 720, and executes the processes described above, according to the programs.

Also, the CPU 710 secures a memory storage region in the primary storage device 720 for the storage unit 170, according to the program. Communication with another device performed by the communication unit 110 is executed by the interface 740 having a communication function and operating under the control of the CPU 710. Display of images performed by the display unit 120 is executed by the interface 740 having a display device and displaying various images under the control of the CPU 710. User operations are accepted through the operation input unit 130 by the interface 740 having an input device and accepting user operations under control of the CPU 710.

In the case where the control device 200 is implemented in the computer 700, operations of the processing unit 280 and each component thereof are stored in the form of a program in the auxiliary storage device 730. The CPU 710 reads out the programs from the auxiliary storage device 730, loads them on the primary storage device 720, and executes the processes described above, according to the programs.

Also, the CPU 710 secures a memory storage region in the primary storage device 720 for the storage unit 170, according to the program. Communication with another device performed by the communication unit 110 is executed by the interface 740 having a communication function and operating under the control of the CPU 710. Display of images performed by the display unit 120 is executed by the interface 740 having a display device and displaying various images under the control of the CPU 710. User operations are accepted through the operation input unit 130 by the interface 740 having an input device and accepting user operations under control of the CPU 710.

In the case where the control device 610 is implemented in the computer 700, operations of the function acquisition unit 611, the action determination unit 612, and the control execution unit 613 are stored in the auxiliary memory storage device 730 in the form of a program. The CPU 710 reads out the programs from the auxiliary storage device 730, loads them on the primary storage device 720, and executes the processes described above, according to the programs.

Moreover, the CPU 710 secures a memory storage region in the primary storage device 720 for the processing to be performed by the control device 610, according to the program. Communication with other devices performed by the control device 610 is executed by the interface 740 having a communication function and operating under the control of the CPU 710. Interaction between the control device 610 and the user is executed by the interface 740 having an input device and an output device, presenting information to the user through the output device under the control of the CPU 710, and accepting user operations through the input device.

In the case where the learning device 620 is implemented in the computer 700, operations of the function acquisition unit 621 and the action determination unit 622 are stored in the auxiliary memory storage device 730 in the form of a program. The CPU 710 reads out the programs from the auxiliary storage device 730, loads them on the primary storage device 720, and executes the processes described above, according to the programs.

Moreover, the CPU 710 secures a memory storage region in the primary storage device 720 for the processing to be performed by the learning device 620, according to the program. Communication with another device performed by the learning device 620 is executed by the interface 740 having a communication function and operating under the control of the CPU 710. Interaction between the learning device 620 and a user is executed by the interface 740 having an input device and an output device, presenting information to the user through the output device under the control of CPU 710, and accepting user operations through the input device.

Any one or more of the programs described above may be recorded in the non-volatile recording medium 750. In such a case, the interface 740 may read the program from the non-volatile recording medium 750. Then, the CPU 710 directly executes the program read by the interface 740, or it may be temporarily stored in the primary storage device 720 or the auxiliary storage device 730 and then executed.

It should be noted that a program for executing some or all of the processes performed by the control device 100, the control device 200, the control device 610, and the learning device 620 may be recorded on a computer-readable recording medium, and the program recorded on the recording medium may be read into and executed on a computer system, to thereby perform the processing of each unit. The “computer system” here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built into a computer system. The above program may be a program for realizing a part of the functions described above, and may be a program capable of realizing the functions described above in combination with a program already recorded in a computer system.

The example embodiments of the present invention have been described in detail with reference to the drawings. However, the specific configuration of the invention is not limited to the example embodiments, and may include designs and so forth that do not depart from the scope of the present invention.

A part or all of the example embodiment described above can be written as in the supplementary notes below, but is not limited thereto.

### Supplementary Note 1

A control device comprising:
a function acquisition means that searches for a function included in the objective function so as to achieve a best possible stability evaluation based on the objective function by using an objective function indicating a stability condition based on a Lyapunov function;
an action determination means that searches for a control rule for a control target so as to achieve a best possible stability evaluation based on the objective function, and determines a control command for the control target based on the obtained control rule; and
a control execution means that controls the control target based on the control command.

### Supplementary Note 2

The control device according to supplementary note 1, comprising:
a real-state-data acquisition means that acquires training data indicating a transition of a state related to the control target under control for the control target using real-state data that indicates a real state, which is a state related to the control target in a real environment;
a latent-state-data acquisition means that converts training data indicating a transition of a state related to the control target under control for the control target as real-state data into training data indicating a transition of a state related to the control target under control for the control target as latent-state data indicating a latent state, which is a state in a virtual environment; and
a transition model acquisition means that trains a latent-state transition model, which is a model for calculating a transition of the latent state under control for the control target, by using training data indicating a transition of a state related to the control target under control for the control target as latent-state data, wherein
the function acquisition means searches for the function, using latent-state data output by the latent-state transition model, and the action determination means searches for the control rule, using latent-state data output by the latent-state transition model.

### Supplementary Note 3

The control device according to supplementary note 2, wherein
the latent-state-data acquisition means performs learning of diffeomorphism, and uses the obtained diffeomorphism to convert training data indicating a transition of a state related to the control target under control for the control target as real-state data into training data indicating a transition of a state related to the control target under control for the control target as latent-state data.

### Supplementary Note 4

The control device according to supplementary note 2 or 3, wherein
the latent-state transition model includes a vector field indicating a time derivative of the latent state, and a numerical integration of a time derivative of a latent state indicated by the vector field, and
the transition model acquisition means performs learning of the vector field.

### Supplementary Note 5

The control device according to any one of supplementary notes 2 to 4, wherein
the action determination means further searches for the control rule, using latent-state data obtained by converting the real-state data obtained under control for the control target in a real environment by the latent-state-data acquisition means.

### Supplementary Note 6

A learning device comprising:
a function acquisition means that searches for a function included in the objective function so as to achieve a best possible stability evaluation based on the objective function by using an objective function indicating a stability condition based on a Lyapunov function; and
an action determination means that searches for a control rule for a control target so as to achieve a best possible stability evaluation based on the objective function, and determines a control command for the control target based on the obtained control rule.

### Supplementary Note 7

A control method executed by a computer, comprising:
searching for a function included in the objective function so as to achieve a best possible stability evaluation based on the objective function by using an objective function indicating a stability condition based on a Lyapunov function;
searching for a control rule for a control target so as to achieve a best possible stability evaluation based on the objective function, and determining a control command for the control target based on the obtained control rule; and
controlling the control target based on the control command.

### Supplementary Note 8

A learning method executed by a computer, comprising:
searching for a function included in the objective function so as to achieve a best possible stability evaluation based on the objective function by using an objective function indicating a stability condition based on a Lyapunov function; and
searching for a control rule for a control target so as to achieve a best possible stability evaluation based on the objective function, and determining a control command for the control target based on the obtained control rule.

### Supplementary Note 9

A recording medium having stored therein a program that causes a computer to execute:
searching for a function included in the objective function so as to achieve a best possible stability evaluation based on the objective function by using an objective function indicating a stability condition based on a Lyapunov function;
searching for a control rule for a control target so as to achieve a best possible stability evaluation based on the objective function, and determining a control command for the control target based on the obtained control rule; and
controlling the control target based on the control command.

### Supplementary Note 10

A recording medium having stored therein a program that causes
a computer to execute:
searching for a function included in the objective function so as to achieve a best possible stability evaluation based on the objective function by using an objective function indicating a stability condition based on a Lyapunov function; and
searching for a control rule for a control target so as to achieve a best possible stability evaluation based on the objective function, and determining a control command for the control target based on the obtained control rule.

This application is based upon and claims the benefit of priority from Japanese patent application No. 2022-175607, filed Nov. 1, 2022, the disclosure of which is incorporated herein in its entirety.

### INDUSTRIAL APPLICABILITY

The present disclosure may be applied to a control device, a learning device, a control method, a learning method, and a recording medium.

### REFERENCE SIGNS LIST

1 Control system
100, 200, 610 Control device
110 Communication unit
120 Display unit
130 Operation input unit
170 Storage unit
180, 280 Processing unit
181 Real-state-data acquisition unit
182 Latent-state-data acquisition unit
185 Transition model acquisition unit
186 Vector field computation unit
187 Numerical integration unit
191, 611, 621 Function acquisition unit
192 Evaluation value calculation unit
193, 612, 622 Action determination unit
194, 613 Control execution unit
620 Learning device
900 Control target

1. A control device comprising:
a memory configured to store instructions; and
a processor configured to execute the instructions to:
search for a function included in the objective function so as to achieve a best possible stability evaluation based on the objective function by using an objective function indicating a stability condition based on a Lyapunov function;
search for a control rule for a control target so as to achieve a best possible stability evaluation based on the objective function, and determine a control command for the control target based on the obtained control rule; and
control the control target based on the control command.

2. The control device according to claim 1, wherein the processor is further configured to execute the instructions to:
acquire training data indicating a transition of a state related to the control target under control for the control target using real-state data that indicates a real state, which is a state related to the control target in a real environment;
convert training data indicating a transition of a state related to the control target under control for the control target as real-state data into training data indicating a transition of a state related to the control target under control for the control target as latent-state data indicating a latent state, which is a state in a virtual environment; and
train a latent-state transition model, which is a model for calculating a transition of the latent state under control for the control target, by using training data indicating a transition of a state related to the control target under control for the control target as latent-state data,
wherein
the processor is further configured to execute the instructions to search for the function, using latent-state data output by the latent-state transition model, and
the processor is further configured to execute the instructions to search for the control rule, using latent-state data output by the latent-state transition model.

3. The control device according to claim 2, wherein
the processor is further configured to execute the instructions to perform learning of diffeomorphism, and use the obtained diffeomorphism to convert training data indicating a transition of a state related to the control target under control for the control target as real-state data into training data indicating a transition of a state related to the control target under control for the control target as latent-state data.

4. The control device according to claim 2, wherein
the latent-state transition model includes a vector field indicating a time derivative of the latent state, and a numerical integration of a time derivative of a latent state indicated by the vector field, and
the processor is further configured to execute the instructions to perform learning of the vector field.

5. The control device according to claim 2, wherein
the processor is further configured to execute the instructions to search for the control rule, using latent-state data obtained by converting the real-state data obtained under control for the control target in a real environment.

6. A learning device comprising:
a memory configured to store instructions; and
a processor configured to execute the instructions to:
search for a function included in the objective function so as to achieve a best possible stability evaluation based on the objective function by using an objective function indicating a stability condition based on a Lyapunov function; and
search for a control rule for a control target so as to achieve a best possible stability evaluation based on the objective function, and determine a control command for the control target based on the obtained control rule.

7. A control method executed by a computer, comprising:
searching for a function included in the objective function so as to achieve a best possible stability evaluation based on the objective function by using an objective function indicating a stability condition based on a Lyapunov function;
searching for a control rule for a control target so as to achieve a best possible stability evaluation based on the objective function, and determining a control command for the control target based on the obtained control rule; and
controlling the control target based on the control command.

8-10. (canceled)
